(19) United States
(12) Patent Application Publication
(10) Pub. No.: US 2026/0312167 A1
(43) Pub. Date: Oct. 8, 2026

(54) THERMAL SYSTEM STRATEGY FOR MOBILE POWER UNITS

(71) Applicant: MOXION POWER CO., Richmond, CA (US)

(72) Inventors: Edward P. YANKOSKI, West Branch, MI (US); Alexander J. SMITH, Lakeside, CA (US)

(73) Assignee: MOXION POWER CO., Richmond, CA (US)

(21) Appl. No.: 19/484,245

(22) PCT Filed: May 15, 2024
(86) PCT No.: PCT/US2024/029522

§ 371 Date: Nov. 13, 2025

Related U.S. Application Data
(60) Provisional application No. 63/502,380, filed on May 15, 2023.

(51) Int. Cl. H01M 10/625; H01M 10/613; H01M 10/63; H01M 10/6551; H01M 10/6563; H01M 10/658; H01M 50/249; H01M 50/293

(52) U.S. Cl. CPC H01M 10/625; H01M 10/613; H01M 10/63; H01M 10/6551; H01M 10/6563; H01M 10/658; H01M 50/249; H01M 50/293; H01M 2220/20

(57) ABSTRACT

A mobile power unit is provided with a number of features. The mobile power unit can include an electrical energy source (ESS) and power electronics. The ESS can be provided in a housing of the mobile power unit, and the power electronics can be disposed in a top portion of the housing above the ESS. Thermal management features are provided that can include active air management in the top portion, while minimizing environmental influences on a thermal mass of the ESS.

### PRIORITY CLAIM

This patent application claims priority to U.S. provisional patent application No. 63/502,380, titled “THERMAL SYSTEM STRATEGY FOR MOBILE POWER UNITS,” and filed on May 15, 2023, which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

The present application relates generally to all-electric, portable industrial power generators which provide temporary on-site power to industries such as construction, film, natural disasters, entertainment, power and utility, electric vehicles, and telecom. More specifically, this disclosure provides a trailer system for transporting a portable energy source.

### BACKGROUND

Temporary electrical power systems are typically used in scenarios in which access to the electrical grid does not exist at a particular site or when the existing electrical grid does not satisfy the power requirements of the site. Examples include construction sites, mining sites, manufacturing sites, shipping locations, areas impacted by natural disasters, temporary event locations, electric vehicle charging, and others (e.g., such as military installations, telecom sites, and residential locations).

All-electric, portable industrial power generators may be used to provide temporary electrical power in cases when traditional internal combustion generators are not desired or cannot be used due to site specific or user specific requirements. The all-electric industrial power generators may rely on a plurality of batteries to provide stored energy that may be converted into alternating current (AC) power on demand. The large number of batteries used in a compact enclosure in combination with high voltage outputs ranging from 120V single-phase to 480V three-phase can result in significant heat generated by the mobile power unit.

### SUMMARY OF THE DISCLOSURE

Described herein are apparatuses, systems, and methods to control temperatures of battery cells, particularly battery cells use with mobile power units designed to provide alternating current power at job sites, construction zones, temporary facilities, disaster relief, or the like.

An all-electric mobile power unit is provided, comprising: a housing; an energy storage compartment disposed in the housing; an electrical energy source (ESS) disposed within the energy compartment of the housing, the ESS comprising a plurality of battery cells; an upper compartment disposed in the housing and positioned above the energy storage compartment, the upper compartment including at least one inlet vent and at least one outlet vent configured to allow air to flow into the upper compartment and exhaust air out of the upper compartment; and power electronics disposed in the upper compartment and configured to control operation of the mobile power unit.

In some aspects, the mobile power unit includes insulation along at least one interior surface of the energy storage compartment.

In one aspect, insulation is located on side walls of the energy storage compartment.

In some aspects, a layer of insulation inside the energy storage compartment forms a thermal barrier between the energy storage compartment and the upper compartment.

In some aspects, insulation is disposed on all interior surfaces of the energy storage compartment.

In some aspects, the mobile power unit includes insulation along at least one interior surface of the upper compartment.

In some aspects, the mobile power unit includes insulation on side walls of the upper compartment.

In one aspect, a layer of insulation inside the upper compartment forms a thermal barrier between the energy storage compartment and the upper compartment.

In some aspects, insulation is disposed on all interior surfaces of the energy storage compartment.

In some aspects, the housing includes a reflective surface.

In some aspects, the mobile power unit has one or more controllable fans disposed within the upper compartment.

In some aspects, the one or more controllable fans are actively controlled to pull air into the at least one vent inlet and exhaust air out of the at least one vent outlet.

In other aspects, the one or more controllable fans are ducted to the inlet vent but not to the outlet vent.

In one aspect, a speed of the one or more fans is speed controlled based on a temperature measurement within the upper compartment.

In some aspects, the one or more controllable fans are centrally located within the upper compartment.

In one aspect, the inlet vent and outlet vent comprise a drain trap configured to prevent water from entering the upper compartment.

In other aspects, the drain trap comprises first and second vertical walls configured to prevent water ingress into the upper compartment.

An all-electric mobile power unit is provided, comprising: a housing; an energy storage compartment disposed in the housing; an electrical energy source (ESS) disposed within the energy compartment of the housing, the ESS comprising a plurality of battery cells; insulation disposed on at least one interior wall of the energy storage compartment, the insulation being configured to minimize environmental influences on a thermal mass of the plurality of battery cells; an upper compartment disposed in the housing and positioned above the energy storage compartment, the upper compartment including active or passive elements for producing a flow of air through the upper compartment; and power electronics disposed in the upper compartment and configured to control operation of the mobile power unit.

In some aspects, the mobile power unit includes insulation on side walls of the energy storage compartment.

In some aspects, a layer of insulation inside the energy storage compartment forms a thermal barrier between the energy storage compartment and the upper compartment.

In other aspects, insulation is disposed on all interior surfaces of the energy storage compartment.

In some aspects, the mobile power unit includes insulation along at least one interior surface of the upper compartment.

In some aspects, the mobile power unit includes insulation on side walls of the upper compartment.

In some aspects, a layer of insulation inside the upper compartment forms a thermal barrier between the energy storage compartment and the upper compartment.

In other aspects, insulation is disposed on all interior surfaces of the energy storage compartment.

In one aspect, the housing includes a reflective surface.

In one aspect, the mobile power unit has at least one inlet vent and at least one outlet vent configured to allow air to flow into the upper compartment and exhaust air out of the upper compartment.

In other aspects, the mobile power unit has one or more controllable fans disposed within the upper compartment.

In some aspects, the one or more controllable fans are actively controlled to pull air into the upper compartment and exhaust air out of the upper compartment.

In another aspect, the one or more controllable fans are ducted to an inlet vent of the upper compartment but not to an outlet vent of the upper compartment.

In one aspect, a speed of the one or more fans is speed controlled based on a temperature measurement within the upper compartment.

In other aspects, the one or more controllable fans are centrally located within the upper compartment.

In some aspects, the inlet vent and outlet vent comprise a drain trap configured to prevent water from entering the upper compartment.

In another aspect, the drain trap comprises first and second vertical walls configured to prevent water ingress into the upper compartment.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 is a view of an example mobile power unit.

FIG. 2 is an example block diagram illustrating the various components and electrical connections within a mobile power unit.

FIG. 3 is a view of an example mobile power unit.

FIG. 4 is another view of a mobile power unit.

FIGS. 5A-5B show one embodiment of a battery module of a mobile power unit.

FIG. 6 is another view of a mobile power unit including features for thermal management.

### DETAILED DESCRIPTION

The present disclosure herein is an over the road vehicle that can include a trailer mounted battery pack system comprising of a steel rack structure, a plurality of battery modules connected in series and parallel configurations, power electronic systems, charging systems, high voltage input output interfaces and a variety of high/low voltage connections. These systems and subsystems are strategically located for optimal performance, commonly connected to the main vehicle structure.

In general, all-electric, portable, industrial power generators include one or more battery cells to provide stored energy that may be converted into electrical AC or DC power. The industrial power generator may use several battery cells to supply sufficient electrical capacity and/or voltage for any DC/DC converters, power inverters, or any other associated circuitry. The battery cells themselves can be removably mounted or affixed into a receiving frame within the industrial power generators.

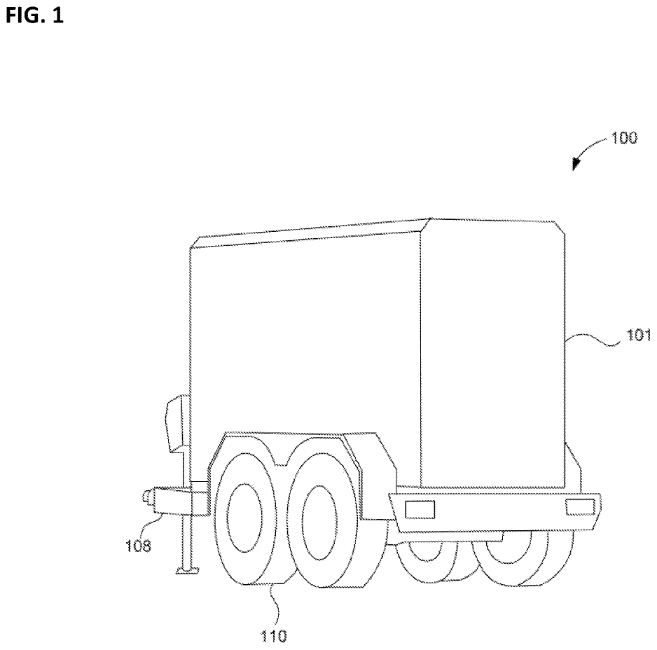

FIG. 1 is a view of an example mobile power unit 100. The mobile power unit 100 may be an all-electric or hybrid power unit configured to provide alternating current (AC) and/or direct current (DC) power on demand for any feasible use. In some embodiments, the desired electrical output is chosen by the user from a pre-selected group of common electrical outputs (e.g., 480 VAC 3-Phase, 208 VAC 3-Phase, 240 VAC 1-Phase, 120 VAC 1-Phase or the like). In another embodiment, the user can select any desired output voltage amplitude, frequency, and phase shift, allowing the mobile power unit to provide any user-selected electrical output. The mobile power unit 100 can further be configured to provide a regulated DC output (e.g., for electric vehicle charging). In some embodiments, the mobile power unit 100 may be controlled through an integrated control panel or through a GUI implemented on a remote device, such as a smartphone, tablet, or PC, which can be configured to communicate with the mobile power unit via wireless technologies such as Bluetooth, Wi-Fi, cellular, etc.

The mobile power unit 100 can include an electrical energy source (EES) disposed within a housing 101. In one configuration, the electrical energy source comprises a plurality of lithium-ion battery cell groups arranged in series and/or parallel connections. In other embodiments, the electrical energy source can comprise other known energy storage devices, such as ultracapacitors or fuel cells. While lithium-ion is presently the preferred battery cell type, it should be understood that other battery cells can be used in place of lithium-ion cells as battery technology evolves. In some examples, the electrical energy source can have an operating voltage range of 300-450 volts. In other embodiments, the electrical energy source can have a higher operating voltage range of 450-1000 volts.

The mobile power unit 100 can include a trailer 108 configured to attach to a trailer hitch or tow vehicle, and a plurality of wheels 110 which allow for easy transportation and delivery of the mobile power unit to remote sites. The size of the mobile power unit 100 can vary depending on electrical output and energy storage capabilities, but in general, the mobile power unit 100 itself can range in size from approximately 50″ long, 30″ wide, and 50″ tall up to 150″ long, 60″ wide, and 60″ tall. The trailer can add an extra 50-70″ in length and 20-30″ in height depending on the size and weight of the mobile power unit 100 and the number and size of wheels required to carry the weight of the mobile power unit 100. In a preferred embodiment, the mobile power unit 100 is approximately 100″ long, 40″ wide, and 60″ tall, with the trailer adding an additional 40-50″ in length and 15-30″ in height. In other embodiments, the mobile power unit can be scaled up or down in terms of operating voltage range and outputs, and the size of the mobile power unit 100 can be adjusted accordingly.

The mobile power unit described herein may be configured to house, support, transport, etc. rechargeable electric power systems comprising one or more components and connections. For example, the mobile power unit can include an electrical energy source (EES) which can comprise, for example, a plurality of battery cells. The electrical energy source can be electrically connected power electronics that may include, for example, a power distribution unit (PDU), which includes a plurality of electrical inputs and outputs configured to distribute electrical power throughout the mobile power unit. The mobile power unit can include additional power electronics, such as a battery management system (BMS), one or more system controllers or processors, electrical connections, inverter stages, power convertors, etc., the details of which are described in related pending applications but is beyond the scope of this disclosure.

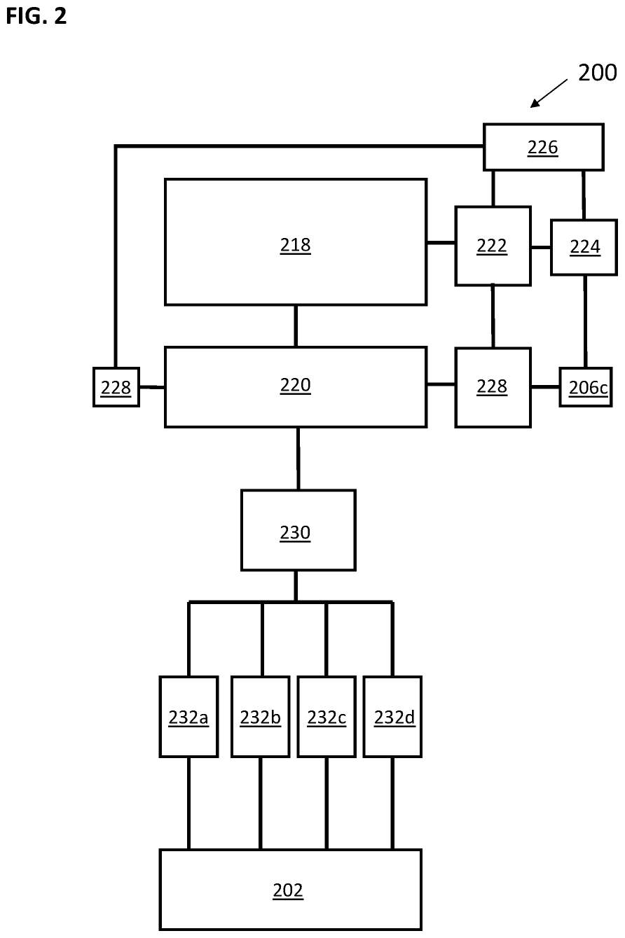

FIG. 2 is an example block diagram illustrating the various components and electrical connections within a mobile power unit 200. The mobile power unit 200 may be an example of the mobile power unit 100 of FIG. 1. The mobile power unit 200 can include an electrical energy source 218 which can comprise, for example, a plurality of battery cells as described above. The electrical energy source 218 can be electrically connected to a power distribution unit (PDU) 220, which includes a plurality of electrical inputs and outputs configured to distribute electrical power throughout the mobile power unit 200. The PDU 220 can be in a centralized location within the mobile power unit 200 for connection/disconnection/fusing of multiple electrical components.

Battery management can be controlled with a battery management system (BMS) 222. The BMS 222 is configured to monitor the state of every battery cell group and can measure any number of battery parameters, including voltage, temperature, current, etc. The BMS 222 is further configured to protect against under and over voltage, measure resistance, estimate charge state, estimate the state of health, and measure power limits of each battery cell group. Additionally, the BMS 222 can be configured to monitor high voltage isolation resistance between the high voltage DC components (such as the electrical energy source 218, the BMS 222, the PDU 220, etc.) and a chassis of the mobile power unit to ensure that this isolation resistance is above acceptable thresholds. In the event of an isolation fault, the BMS 222 can be configured to shut-down the system until the fault is cleared by enabling/disabling the electrical energy source 218.

The temperature measurement of the electrical energy source 218 can be used by the BMS 222 for estimations, as safety limits for over temperature, and cold temperature charging limits to prevent lithium plating. The BMS 222 can also be configured to perform cell group level balancing to maximize the performance of the mobile power unit 200.

Battery charging can be controlled with an on-board battery charger 224. As shown, the on-board battery charger 224 can be electrically coupled to both the PDU 220 and the electrical energy source 218 via the BMS 222. The battery charger 224 is connected to/fused within the PDU 220 in case there is a short circuit. The battery charger 224 can be air or liquid cooled and can be configured to regulate itself (i.e., if an over-temperature event were to occur the battery charger can automatically shut-down). The battery charger 224 can communicate with the BMS 222 to regulate the charge current and ensure no cells in the electrical energy source are over-charged.

The mobile power unit 200 can be configured to utilize existing electric vehicle charging infrastructure and components (the Combined Charging System, or CCS) to charge its battery energy source 218. Therefore, an optional CCS controller 228 can facilitate charging on a CCS network via an AC power source or alternatively via an off-board DC fast charger. The CCS controller 228 can be coupled to/configured to communicate with the BMS 222 and an electrical connector 206c to control the AC and/or DC charging of the electrical energy source 218 on the CCS network.

Charging of the electrical energy source 218 from external power sources can be accomplished via a connector 206c on an interface panel of the mobile power unit. For example, the connector 206c can be a SAE J1772 connector that, in turn, can be connected to an external power source to charge the mobile power unit 200. It should be understood that other electrical connector types can be used for charging the mobile power unit 200.

The mobile power unit 200 can further include an overall system controller or electronic control unit (ECU) 226 which can configure/control the overall operation of the mobile power unit. In some embodiments, the controller can be integrated into the user interface or GUI described above. The system controller or ECU 226 can communicate with the other microcontrollers of the mobile power unit (such as the BMS 222, the CCS controller 228, etc.) via a Controller Area Network (CAN bus), for example. A low voltage DC/DC converter 228 can be used to regulate the voltage for the controllers and microcontrollers of the mobile power unit. For example, the low voltage DC/DC converter 230 can convert the high voltage from the electrical energy source 218 (e.g., 300-450V) to a much lower voltage (e.g., 12V) to operate various controllers and microcontrollers. The ECU 226 can monitor all functions and features of the mobile power unit 200, and can be configured to communicate information to a distribution center via wired or wireless communication. For example, the ECU 226 can monitor and communicate information relating to the mobile power unit 200 or electrical energy source 218, such state of charge, state of health, temperature, etc. to a remote location.

The mobile power unit 200 can further include a high voltage DC/DC converter 230 electrically coupled to the PDU 220. The high voltage DC/DC converter 230 can be configurable to operate in a plurality of different modes. In one specific embodiment, the high voltage DC/DC converter 230 can operate in two distinct configurations. For example, in a first configuration, the high voltage DC/DC converter 230 can operate as a boost converter in which it is configured to boost an unregulated electrical energy source voltage 218 (e.g., an unregulated battery voltage of 300-450V) up to an elevated DC voltage that is regulated (e.g., such as up to a regulated 750-850V DC). Similarly, if the unregulated battery energy source 218 voltage is lower than it should be (e.g., the expected voltage is at least 325V, but the actual voltage is lower), then the high voltage DC/DC converter 230 could be configured to increase the voltage of the electrical energy source 218 to the expected source voltage. In some embodiments, the high voltage DC/DC converter 230 can be configured to slowly ramp-up from the battery voltage to the higher voltage to avoid hard starting the system (e.g., the mobile power unit 200). In a second configuration, the high voltage DC/DC converter 230 can operate as a pass-through, in which the output voltage of the high voltage DC/DC converter 230 is the same as the electrical energy source 218 voltage (e.g., an unregulated 300-450V). In other embodiments, it may be desirable to reduce the unregulated battery energy source voltage to a reduced DC voltage. For example, some embodiments of the mobile power unit 200 can include an energy source with a source voltage of up to 1000V. In these implementations, it would therefore be necessary for the high voltage DC/DC converter 230 to reduce the source voltage down to 300-450V for use within the mobile power unit 200. In these embodiments, the high voltage DC/DC converter 230 could be or operate as, for example, a buck converter.

The mobile power unit 200 can further comprise one or more inverter stages, or alternatively, a multi-stage inverter, electrically coupled to the output of the high voltage DC/DC converter 230. Example inverter stages are illustrated as inverter stages 232a-232d in FIG. 2. However, persons skill in the art will appreciate that any number of inverter stages can be implemented depending on the desired output of the mobile power unit 200. In some embodiments, the inverter stages can utilize the same hardware (or similar hardware) as the high voltage DC/DC converter 230, but can instead be controlled differently through specific CAN bus commands from the ECU 226. In other embodiments, the inverter stages can implement different electrical topologies than illustrated/described herein. Each inverter stage has a DC input from the high voltage DC/DC converter 230 and is configured to create an AC output utilizing 3-phases. In one specific implementation, each phase can support a current of 32 A for a total current of 96 A peak per phase (e.g., if the inverter stages are operated in parallel as a single phase). According to the present disclosure, the ECU 226 is configured to combine the plurality of inverter stages at various phase shifts to create 3-phase and split-phase outputs, which are passed to the interface panel and the electrical connections as described above. AC and/or DC outputs from any of the inverter stages 232a-232d may be provided to output panel 202.

In some examples, any, all or none of the electrical components and connections may be couple to or in communication with the mobile power unit trailer systems described herein.

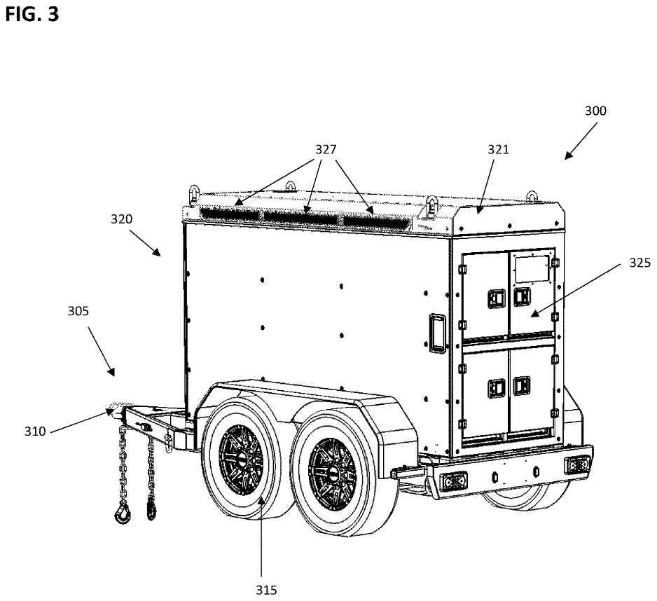

Additional details of a mobile power unit 300 are shown in FIG. 3. A trailer frame 305 has a coupler 310 and wheels 315 to facilitate maneuverability of the mobile power unit 300. A housing 320 is positionable on the towable frame 305 and can be configured to house an energy source (e.g., electric power source) therein. The housing 320 can have a top portion 321 separated from the towable frame 305 by sidewalls. The top portion 321 can house the power electronics, such as those described above (e.g., in FIG. 2). Additionally, the top portion can include a plurality of vents 327 disposed on one or more sides of the top portion 321. In some embodiments, vents 321 on one side of the top portion can act as air inlets to draw cool air into the top portion 321, and vents on the opposite side of the top portion can act as air outlets to expel hot air out of the top portion 321. Access panels 325 can be configured to provide access to an interior of the housing 300 and may be locatable on any surface of the housing 300. For example, FIG. 3 illustrates an example of access panels 325 at the rear of the housing 320.

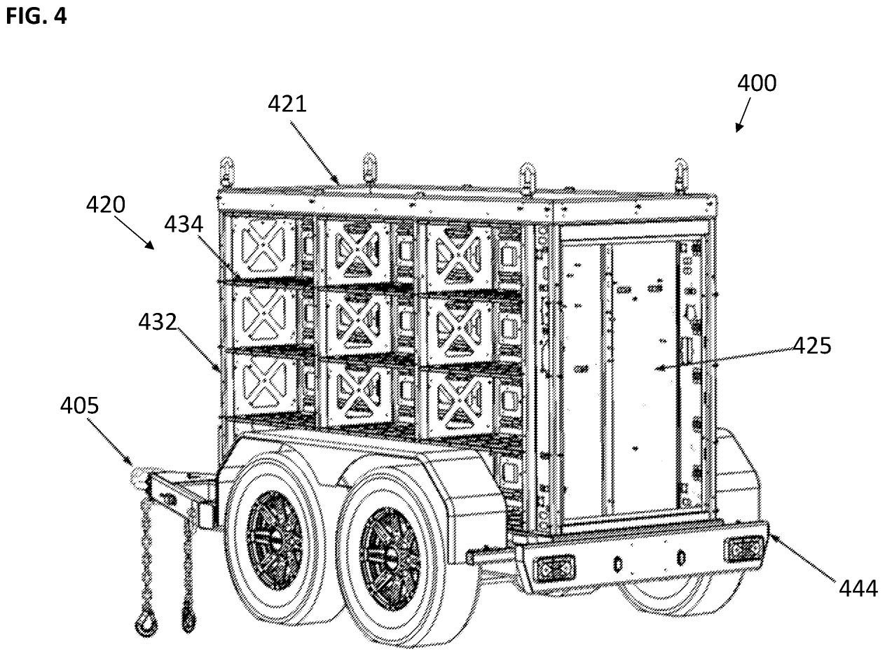

FIG. 4 illustrates an example of a mobile power unit 400 with sidewalls removed to expose internal detail of the housing 420. In this view, the mobile power unit includes a trailer frame 405, a rechargeable energy storage system rack structure 432, battery module shelves 434, top portion 421, and rear bumper 444. The individual battery units or battery modules described above can be housed in the rack structure 432, each battery unit or module being supported by a battery module shelf 434. Here, the top portion 421 is configured to provide a frame for housing many electrical components of the mobile power unit, such as the inverters, BMS, PDU, etc. described above.

Referring to FIG. 4, rear access panel 425 may be positioned within the housing 420. The rear access panel can provide user access to one or more electrical outputs of the mobile power unit (e.g., for connecting a load to the 480 VAC 3-Phase, 208 VAC 3-Phase, 240 VAC 1-Phase, 120 VAC 1-Phase, etc. electrical outputs. The rear access panel 425 can further provide access to one or more user panels, displays, or input devices, such as a graphical user input (GUI) device or display.

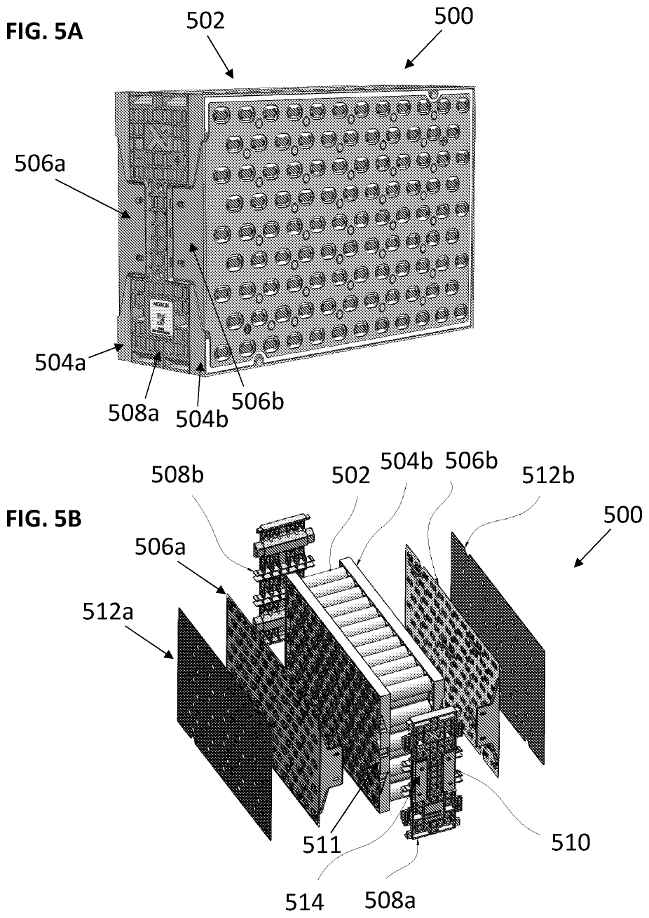

FIGS. 5A-5B show isometric and exploded views, respectively, of an example battery module or housing 500. The battery module 500 can be used to house, protect, and mount any feasible battery cell within a mobile power unit, such as within the racks 432 and shelves 434 described above in FIG. 4. In some examples, the battery module 500 may be used to affix one or more batteries 502 (battery cells) within the mobile power unit. As used herein, the terms battery and battery cells are interchangeable and can describe any feasible energy storage unit, device, or the like. The battery cells can include any number of batteries that are interconnected in a parallel and/or serial fashion to provide an input voltage to the electronics of the mobile power unit. The battery modules of the present disclosure generally have the shape of a rectangular prism, however other shapes (e.g., cube, etc.) are contemplated. The battery module 500 may include a battery housing that partially or completely surrounds, and is securely attached to, the battery cells.

In the illustrated embodiment, the battery module 500 can include a housing that comprises a first battery housing assembly 504a and a second battery housing assembly 504b. The batteries of the battery module may be sandwiched or placed between the first and second battery housing assemblies 504a and 504b. For example, the negative terminals of the batteries may be placed within the first battery housing assembly 504a, and the positive terminals of the batteries may be placed within the second battery housing assembly 504b.

In some variations, the battery housing may surround four sides of the battery. For example, the battery housing may further include front battery housing assembly 508a and rear battery housing assembly 508b. In some implementations, the front and rear battery housing assemblies may include engagement, interlocking, or attachment features 510. The attachment features 510 may be configured to engage with corresponding features 511 on the first and second battery housing assemblies 504a and 504b. In the illustrated embodiment, the attachment features 510 comprise clips, tabs, or fingers that are configured to be inserted into receiving features in the first and second battery assemblies. For example, any interference fit or permanent/semi-permanent fixation techniques including screws, nails, or adhesive can be used to hold or bond the front and rear battery assemblies to the side (first and second) battery assemblies. Other types of attachment or engagement features known in the art are within the scope of this disclosure. The components of the battery housing may be further attached or coupled together with adhesive to further strengthen the bond between the first, second, front, and rear battery assemblies. Adhesive bonding between the first, second, front, and rear battery assemblies provides a full “cage” like exoskeleton adding to the overall battery module robustness.

The battery housing, including the first, second, front, and rear battery housing assemblies, can be formed from heat-resistant plastic, extruded or machined metals, or a combination of any of these materials.

The battery module can include a pair of bus bars or bus plates 514 configured to interface with first and second current collectors 506a and 506b which act as electrical conductors for current to flow to and from the battery cells within the battery module. In the embodiment of FIGS. 5A-5B, the bus plates 514 are disposed on the front battery housing assembly 508a. However, it should be understood that these bus plates can be disposed on any of the battery assemblies. In this example, the first current collector 506a can be a negative current collector and the second current collector 506b can be a positive current collector. Although two current collectors are shown in this embodiment, it should be understood that any number of current collectors can be implemented. The bus plates 514 in this embodiment are positioned on the front battery housing assembly 508a. However, it should be understood that the bus plates can be located anywhere on the battery housing, including on the first, second, front, or rear battery housing assemblies.

FIG. 5B shows optional battery thermal barriers 512a and 512b. The thermal barriers can comprise non-conductive materials configured to isolate or reduce the amount of heat transferred between adjacent battery modules. Additionally the thermal barriers can be configured to vent gas and prevent escaping gasses and ejecta from reaching neighboring battery modules. In the illustrated embodiment, the thermal barriers are placed on an outside surface of the current collectors. The thermal barriers provide a tortuous path for venting gasses. In the unlikely event of a thermal runaway incident, the thermal barrier layer includes trapezoidal cutouts that create a deflection path for pressurized gasses and ejecta.

As described above, mobile power units of the present disclosure can generally include two major sub-systems: the battery energy storage system (ESS), including the battery modules described above in FIGS. 5A-5B, and the power electronics as described in the schematic diagram of FIG. 2. Both have different cooling or heating needs depending on the application. This disclosure provides a thermal strategy for mobile power units that maximizes the use of passive thermal management techniques with minimal active thermal management. The benefit is reduced cost, complexity, and power consumption while increasing reliability.

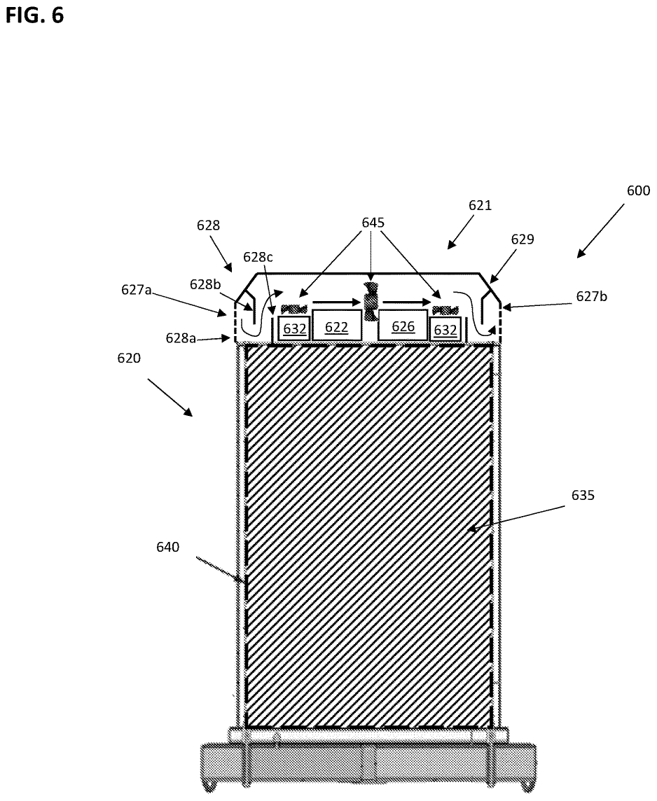

The ESS in this disclosure generates very little heat under normal operating conditions, therefore most of the heating load comes from the outside environment rather than internal heat generation. FIG. 6 shows a cross-sectional view of a mobile power unit 600 including a housing 620 that includes an ESS portion 635 and a top portion 621.

As described above, the top portion 621 can be configured to house power electronics such as those previously described in FIG. 2. For example, the top portion 621 can house one or more inverter stages 632, a BMS 622, and an ECU 626, in addition to other electronics and circuitry described above. Additionally, the top portion can include one or more sensors, including temperature sensors, configured to measure a temperature in the top portion. In some examples, the temperature sensors are integrated into the power electronics. As shown, the top portion 621 of the housing 620 is disposed or placed above the ESS portion of the housing, like an attic of the mobile power unit.

The ESS portion 635 can be configured to house the energy source(s) of the mobile power unit, such as a plurality of battery modules as described above. Additionally, the ESS portion can house electrical connections between the plurality of battery modules themselves, and/or electrical connections between the ESS and the power electronics in the top portion. Additionally, the ESS portion can include one or more sensors, including temperature sensors, configured to measure a temperature in the ESS portion. In some examples, the temperature sensors are integrated into the battery modules.

The top portion 621 of the mobile power unit gets the majority of the solar load over the course of the day, particularly when the mobile power unit is placed or stored outdoors. In some examples, as shown, the top portion can have one or more beveled edges 629 to reduce a footprint or surface area of the top portion with respect to the surface area or footprint of the ESS portion. To prevent heat build-up and to cool the power electronics, the top portion 621 is configured to actively and/or passively control air flow across the top portion. In some embodiments, the top portion is passively cooled, and air is allowed to flow into vent inlets 627a, pass through the top portion, and exit through vent outlet 627b.

In other embodiments, the top portion is actively cooled with the addition of controllable fans, configured to actively pull air into vent inlet 627a and push air out of vent outlet 627b. By constantly pulling in fresh ambient air through vent inlet(s) 627a with one or more fans 645 and exhausting hot air through vent outlet(s) 627b, the top portion 621 can be actively controlled to essentially act as a “cooled” attic above the ESS portion and housing and can keep the heat load down in the mobile power unit. As shown in FIG. 6, the fans 645 can be placed strategically within the top portion 621 to assist in air flow. For example, fans can be placed on or near inverter stages 632 or other electronic components known to generate heat. Fans can also be placed centrally within the top portion, or near the vents 627a/b to pull cool air into the top portion and push warm/hot air out of the top portion.

As shown in FIG. 6, airflow can be controlled by one or more fans 645 located in the top portion 621. In some embodiments, the one or more fans can be positioned centrally to reduce external noise when running since fans are typically the largest source of noise in an air-cooled system. The fan can be directly ducted on the inlet vent to pull in fresh air, but unducted on the outlet vent. This creates a “positive pressure” chamber in the top section to continually flush fresh air over multiple electronic devices without creating a complex ducting system. Individual components then have either static heat sink fins or localized fans to self-regulate depending on their needs.

In some embodiments, the fan(s) can comprise a blower type fan due to packaging, pressure drop, and noise requirements. However, alternative fans such as axial or cross-flow type fans could also be used. The fan(s) can be variable speed and controlled by one or more processors of the power electronics, or a separate ECU. Fan speed can be determined depending on the cooling needs of the power electronics and/or ambient top portion air temperature.

Because the top portion 621 includes power electronics, there is additionally a need to prevent water from entering into the top portion through the vents 627a and 627b. This can be accomplished in one embodiment by creating a “drain trap” type air flow channel 628 for any air entering/exiting the top section through vents 627a/b. The bottom of the “drain trap” has a path 628a for water to exit to prevent buildup. For example, the path 628a can allow for fluid drainage through the vent 627a, or alternatively, can have a separate structure such as channels, lumens, tubes, or ports to allow fluid to drain out of the top portion 621. For example, referring to FIG. 6, it can be seen how air entering through vent inlet(s) 627a can encounter a first vertical wall 628b in the vent that diverts the air flow down to the drain trap path 628a or bottom of the vent. Another vertical wall 628c interior to the first interior wall 628b then diverts the air back up and into the top portion 621. The second interior vertical wall prevents water ingress, and along with the drain trap path allows for water to exit the vents without entering the top portion. Drains to the outside of the mobile power unit can be incorporated at any point along the drain trap path.

In cold operating temperature, the ESS may require heating. In this system, heating pads are located within the ESS, as described in a pending related provisional application. The heating pads can use a special PTC ink that self regulates to a pre-defined target temperature. This simplifies the controls and makes it fault tolerant in the event of a short circuit.

For actual operation, the mobile power unit can be “pre-heated” on plug before deployment. Because of its large thermal mass, the ESS of the mobile power unit will sustain its temperature with minimal additional heat input during operation before it is fully discharged and needs to return to a charging source.

For cooling, the system is naturally cooled at night once the sun goes down. For additional cooling, the fan speed can be increased. When the sun comes up the next day, fan speeds may be kept low to limit heat transfer from a “hotter” environment to a “cooler” ESS.

The design of this mobile power unit is configured to leverage the large thermal mass of the ESS to self-regulate its temperature. In some embodiments, the thermal load of the ESS can be separated from heat generated in the top portion by insulating the side, top, and/or bottom walls of the housing with insulation 640. Any thermal insulation known in the art can be used, including insulation used for electronic components and/or insulation used for buildings/construction. For example, the barrier or separation between the ESS portion and the top portion can be insulated. Alternatively or additionally, the top portion 621 of the housing can also be insulated, either by itself or when the ESS portion is insulated. In some instances an exterior of the housing 620 may be reflective to reject a larger amount of solar loading.

The mostly passive thermal strategy for mobile power units described herein relies on the thermal mass of the batteries or ESS to self-regulate (dampen) the temperature of the mobile power unit, and the overall design of the mobile power unit including the location of the system electronics in the “attic” at the top portion of the housing, above the ESS, focuses on minimizing the environmental influences on changing that temperature or thermal mass of the ESS. The main environmental influences are ambient air temperature and solar radiation. Solar radiation can be minimized by reducing the external surface area of the enclosure, and in particular the top portion, (e.g., making the housing as small as possible) and then adding in a layer of insulation on the side walls to also dampen the external temperatures from reaching the battery or ESS core. The top portion of the mobile power unit sees the highest solar loading (as do all roofs) and can therefore include both insulation and active air-flow in the “attic” area to keep temperatures down and out of the core of the battery pack (e.g., the ESS portion of the housing). In some examples, the active area cooling is predominately for the inverters, but has the secondary effect of keeping heat loads away from the battery packs or ESS.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. An all-electric mobile power unit, comprising:
a housing;
an energy storage compartment disposed in the housing;
an electrical energy source (ESS) disposed within the energy compartment of the housing, the ESS comprising a plurality of battery cells;
an upper compartment disposed in the housing and positioned above the energy storage compartment, the upper compartment including at least one inlet vent and at least one outlet vent configured to allow air to flow into the upper compartment and exhaust air out of the upper compartment; and
power electronics disposed in the upper compartment and configured to control operation of the mobile power unit.

2. The mobile power unit of claim 1, further comprising insulation along at least one interior surface of the energy storage compartment.

3. The mobile power unit of claim 2, further comprising insulation on side walls of the energy storage compartment.

4. The mobile power unit of claim 2, wherein a layer of insulation inside the energy storage compartment forms a thermal barrier between the energy storage compartment and the upper compartment.

5. (canceled)

6. The mobile power unit of claim 1, further comprising insulation along at least one interior surface of the upper compartment.

7. The mobile power unit of claim 6, further comprising insulation on side walls of the upper compartment.

8. The mobile power unit of claim 6, wherein a layer of insulation inside the upper compartment forms a thermal barrier between the energy storage compartment and the upper compartment.

9. (canceled)

10. The mobile power unit of claim 1, wherein the housing includes a reflective surface.

11. The mobile power unit of claim 1, further comprising one or more controllable fans disposed within the upper compartment.

12. (canceled)

13. (canceled)

14. The mobile power unit of claim 11, wherein a speed of the one or more fans is speed controlled based on a temperature measurement within the upper compartment.

15. (canceled)

16. The mobile power unit of claim 1, wherein the inlet vent and outlet vent comprise a drain trap configured to prevent water from entering the upper compartment.

17. (canceled)

18. An all-electric mobile power unit, comprising:
a housing;
an energy storage compartment disposed in the housing;
an electrical energy source (ESS) disposed within the energy compartment of the housing, the ESS comprising a plurality of battery cells;
insulation disposed on at least one interior wall of the energy storage compartment, the insulation being configured to minimize environmental influences on a thermal mass of the plurality of battery cells;
an upper compartment disposed in the housing and positioned above the energy storage compartment, the upper compartment including active or passive elements for producing a flow of air through the upper compartment; and
power electronics disposed in the upper compartment and configured to control operation of the mobile power unit.

19. (canceled)

20. (canceled)

21. (canceled)

22. (canceled)

23. (canceled)

24. (canceled)

25. (canceled)

26. The mobile power unit of claim 18, wherein the housing includes a reflective surface.

27. The mobile power unit of claim 18, further comprising at least one inlet vent and at least one outlet vent configured to allow air to flow into the upper compartment and exhaust air out of the upper compartment.

28. The mobile power unit of claim 18, further comprising one or more controllable fans disposed within the upper compartment.

29. The mobile power unit of claim 28, wherein the one or more controllable fans are actively controlled to pull air into the upper compartment and exhaust air out of the upper compartment.

30. The mobile power unit of claim 28, wherein the one or more controllable fans are ducted to an inlet vent of the upper compartment but not to an outlet vent of the upper compartment.

31. The mobile power unit of claim 28, wherein a speed of the one or more fans is speed controlled based on a temperature measurement within the upper compartment.

32. (canceled)

33. The mobile power unit of claim 27, wherein the inlet vent and outlet vent comprise a drain trap configured to prevent water from entering the upper compartment.

34. The mobile power unit of claim 33, wherein the drain trap comprises first and second vertical walls configured to prevent water ingress into the upper compartment
